(19) United States
(12) Patent Application Publication
(10) Pub. No.: US 2009/0189803 A1
(43) Pub. Date: Jul. 30, 2009

(54) ANTENNA CONFIGURATION FOR DEVICE HAVING LOCATION DETERMINING CAPABILITY

(75) Inventor: Lawrence W. Beason, Overland Park, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., George Town (KY)

(21) Appl. No.: 12/019,221

(22) Filed: Jan. 24, 2008

(51) Int. Cl. G01S 5/00

(52) U.S. Cl. 342/357.1; 342/450; 342/357.06

(57) ABSTRACT

An electronic device comprises a location determining component such as a GPS receiver, or the like, which employs multiple antennas configured for use when the device is in various orientations.

### BACKGROUND

The present invention is directed to an electronic device having location determining capability, and more particularly to a device having two or more location determining component antennas each configured for use when the device is various modes of operation or orientations.

Existing electronic devices which are provided with location determining capability (e.g., GPS-enabled devices) are typically designed to have only one major use. For example, GPS navigation devices used in automobiles are normally meant to be attached to a mounting device which is coupled to a surface of the interior of the automobile (e.g., the interior windshield, dashboard, etc.), while devices such as hand-held GPS devices and GPS-enabled mobile phones are meant for hand-held use. In such devices, the GPS antenna is selected and positioned to provide greatest efficiency during use in a normal use orientation (e.g., while docked in a fixed automobile mount, held in a user's hand, held adjacent to a user's ear, etc.) within the design constraints of the device. However, when the device is oriented in a fashion other than the orientation in which it was designed to be used, the efficiency of its GPS antenna can be greatly reduced resulting in lost satellite reception, longer time to obtain a satellite lock, or decreased position accuracy.

### SUMMARY

The present invention is directed to an electronic device employing a location determining component such as a GPS receiver, or the like, wherein the location determining component employs multiple antennas configured and/or positioned for use when the device is in various modes of operation or orientations.

In exemplary implementations of the invention, the device is capable of use in two or more operational modes or orientations. The device includes a location determining component (such as a GPS receiver, or the like) for determining a geographic location of the device. Two or more antennas are disposed in the housing for receiving a signals used by the location determining component for determining the geographic location of the device. Each of the antennas are configured or positioned for use by the location determining component when the device in one or more of the operational modes or orientations so that he the location determining component uses signals received by a first antenna when the device is in at least one of a first operational mode and a first orientation and signals received by a second antenna when the housing in at least one of a second operational mode and a second orientation and so on. The device further includes a detector for detecting whether the device should be in at least one of the first operational mode or the second operational mode or is in the first orientation or the second orientation so that the appropriate antenna may be selected for use by the location determining component.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are exemplary and explanatory only and are not necessarily restrictive of the invention claimed. The accompanying drawings, which are incorporated in and constitute a part of the specification, illustrate embodiments of the invention and together with the Detailed Description, serve to explain the principles of the invention.

### BRIEF DESCRIPTION OF THE DRAWING FIGURES

Embodiments of the present invention are described in detail below with reference to the attached drawing figures, wherein:

FIG. 1 is an isometric view illustrating a device constructed in accordance with an exemplary embodiment of the present invention;

FIG. 2 is an isometric view of the device shown in FIG. 1, further illustrating the device being docked in a mount;

FIG. 3 is a block diagram illustrating the interaction of components of the device shown in FIGS. 1 and 2;

FIG. 4 is an cross-sectional view of the device shown in FIG. 1, further illustrating the circuit board of the device and an exemplary position of the antennas within the device's housing; and

FIG. 5 is an isometric view of the circuit board of the device shown in FIG. 4, further illustrating the position of the antennas with respect to one another.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The detailed description is described with reference to the accompanying figures. The use of the same reference numbers in different instances in the description and the figures may indicate similar or identical items.

### Overview

In most electronic devices equipped with location determining components such as GPS receivers, or the like, the antenna for the location determining component is configured and/or positioned to provide the greatest efficiency possible within the design constraints of the device (e.g., so that the antenna may be enclosed within the housing of the device along with the other components of the device). For example, GPS navigation devices used in automobiles are typically designed to be attached to a mounting device which is coupled to a surface of the interior of the automobile (e.g., the interior windshield, dashboard, etc.). In such devices, the GPS antenna is normally positioned to have a “view of the sky” through the automobile's windshield for best possible reception of signals broadcast by GPS satellites. Where such GPS navigation devices are further designed for handheld use, such as with the Nüvi® series of personal navigation devices manufactured by Garmin International, Inc. of Olathe, Kans., the handheld use typically does not change the orientation of the antenna to such an extent that performance of the GPS antenna is degraded beyond acceptable limits. In contrast, GPS-enabled handheld devices such as GPS-enabled mobile phones are meant for hand-held use. Unlike GPS navigation devices, which typically have landscape oriented displays most suited for displaying navigation information such as maps, turn-by-turn directions, vehicle speed and direction information, or the like, handheld devices typically employ portrait oriented displays best suited for use while the device is held in the user's hand with the display facing upward. In such devices, the GPS antenna is selected, configured and/or positioned to provide greatest efficiency during use in a normal use orientation (e.g., held in a user's hand, etc.). However, when the device is oriented in a fashion other than that of its normal use, the efficiency of its GPS antenna is greatly reduced resulting in lost satellite reception, longer time to obtain a satellite lock, or decreased position accuracy.

The present invention comprises an electronic device employing a location determining component such as a GPS receiver, or the like, wherein the location determining component is designed for use in while the device is in two or more modes of operation or orientations. For example, in one embodiment, the device may comprise a mobile phone having integrated navigation capability. In such an embodiment, the mobile phone may include a display capable of use in both landscape and portrait orientations for displaying information to the user. In a first operational mode, the mobile phone may be received in a mount within an automobile and positioned in a first orientation (e.g., so that its display is useable in a landscape orientation) for use in providing navigation functions, and, in a second operational mode, held by a user in a second orientation (e.g., so that its display faces upward and is usable in a portrait orientation) for better use of its telephony features.

In accordance with the present invention, the location determining component employs two or more antennas each configured for use when the device is in one or more operational modes or orientations. For example, in the specific embodiment wherein the device comprises a mobile phone having integrated navigation capability, the device may include a first antenna disposed in the housing and operable for receiving a signals used by the location determining component for determining the geographic position of the device when the device is in a first operational mode or first orientation such as when the device is held within the hand of a user with the display facing upward and a second antenna disposed in the housing and operable for receiving a signals used by the location determining component for determining the geographic position of the device when the device is in a second orientation such as when the device is mounted in a generally vertical orientation in a mount within an automobile. The mode of operation or orientation of the mobile phone is detected and the appropriate antenna selected to optimize receipt of signals for the location determining component.

### EXEMPLARY ENVIRONMENT

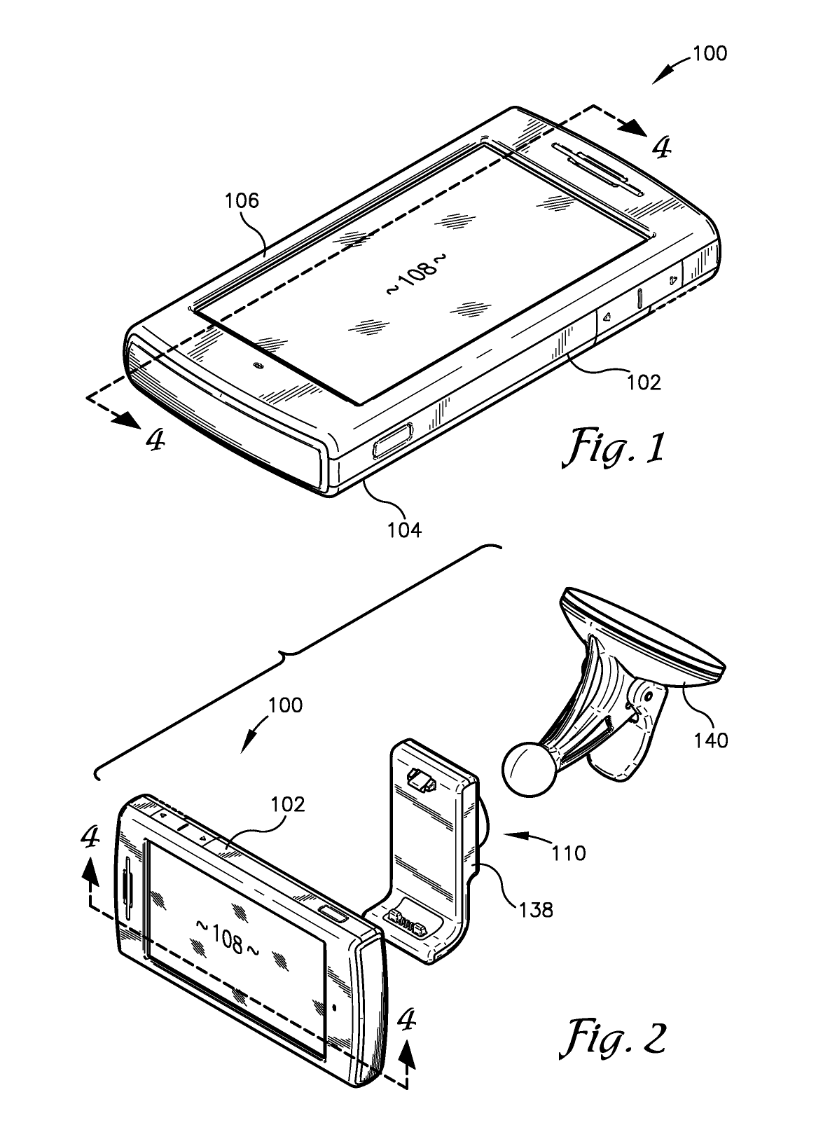

Referring generally to FIGS. 1, 2 and 3, a device 100 constructed in accordance with an exemplary embodiment of the present invention is described. As illustrated, the device 100 may comprise a mobile phone which includes a housing 102 shaped to be held in the hand of a user (as shown in FIG. 1). The housing 102 which is generally rectangular in shape includes a bottom surface 104 and a top surface 106 generally facing away from the bottom surface 104 and user hand. A display 108 is disposed in the top surface 106 so that it may be viewed by a user of the device 100 while the device 100 is held in the hand. As shown in FIG. 2, the device may also be mounted or docked in a mounting device or mount 110 which may then be coupled to a surface of the interior of the automobile (e.g., the interior windshield, dashboard, etc.), the handlebars of a motorcycle or bicycle, or the like. As shown, when docked in the mount 110 the device 100 is oriented so that the display 108 is again positioned to be viewed by the user.

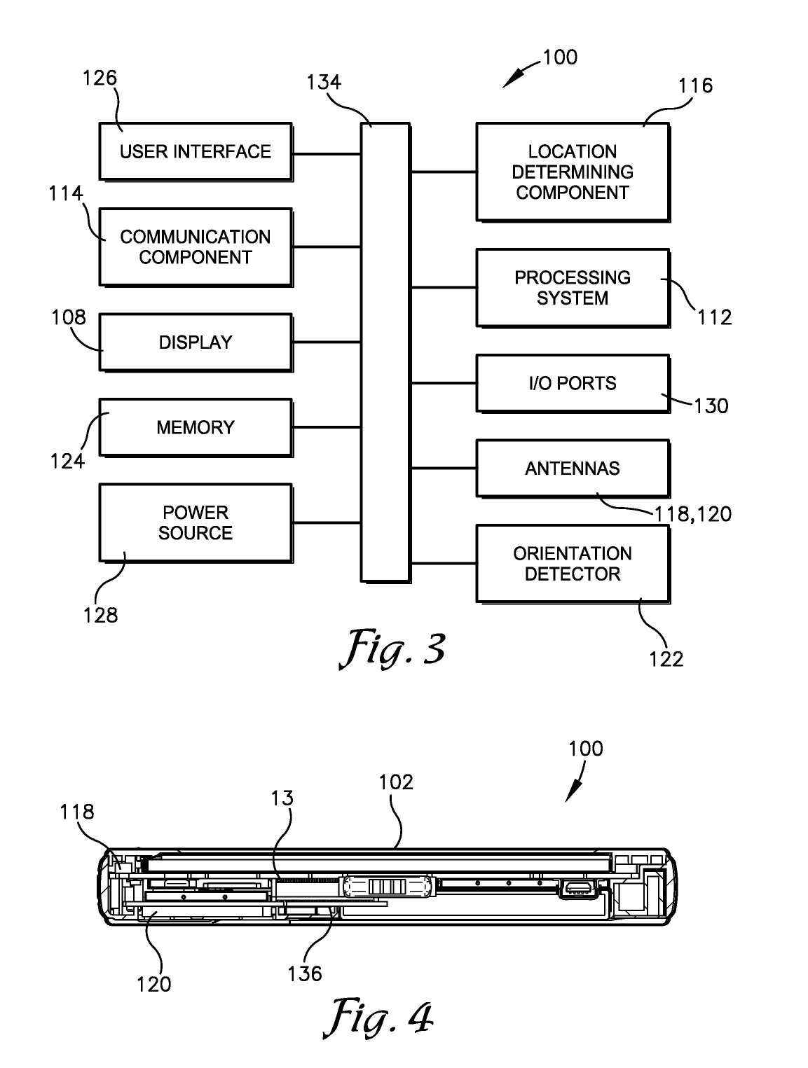

As best illustrated in FIG. 3, the electronic device 100 may include a processing system 112, communication component 114, a location-determining component 116, two or more location-determining component antennas (two antennas 118 & 120 are illustrated), the display 108, and an detector 122. The device 100 may also include memory 124, a user interface 126, a power source 128, and one or more input/output (I/O) ports 130. These components may be mounted to one or more circuit boards 132 within the housing 102 of the device 100.

The processing system 112 may include any number of processors, controllers, integrated circuits, programmable logic devices, or other computing devices and resident or external memory for storing data and other information accessed and/or generated by the device 100. The processing system 112 may be coupled with the communications component 114, the location determining component 116, the display 108, memory 124, the user interface 126, and other components through wired or wireless connections, such as a data bus 134, to enable information to be exchanged between the various components.

The processing system 112 may implement one or more computer programs and/or code segments to perform the functions described herein. Such computer programs or code segments may comprise an ordered listing of executable instructions for implementing logical functions in the processing system 112. The computer programs or code segments can be embodied in any computer-readable medium for use by or in connection with an instruction execution system, apparatus, or device, and execute the instructions. In the context of this application, a “computer-readable medium” can be any means that can contain, store, communicate, propagate or transport the program for use by or in connection with the processing system 112. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a random access memory (RAM), a read-only memory (ROM), an erasable, programmable, read-only memory (EPROM or Flash memory (e.g., SD Card, mini-SD card, micro-SD Card), etc.), a portable computer diskette, and a portable compact disk read-only memory (CDROM), DVD, or the like.

The communications component 114 enables the device 100 to communicate with other electronic devices through a communication network. In one embodiment, the communication component may comprise a cellular transceiver for transmitting and receiving communications over a cellular phone network. The cellular phone network may employ any common air interface standard such as GSM (Global System for Mobile communications), CDMA (Code Division Multiple Access), or any other known standards. The communications component 112 may make and receive communications including incoming and outgoing cellular telephone calls, text messages (including Short Message Service (SMS) messages, Enhanced Messaging Service (EMS) messages, Multimedia Messaging Service (MMS) messages, and the like), instant messages (IM), voicemail messages, e-mail messages, missed phone calls, Internet, and any other known communications.

The communications component 114 may also permit communications over other networks and may include one or more transmitters, transceivers and/or receivers and associated antennas to enable wireless transmission of information. For example, the device 100 may be operable to transmit and receive communications over a local area network, a wide area network, an ad hoc or peer to peer network, or a direct connection such as a USB, Firewire, or Bluetooth™ connection. The communications component 112 may communicate utilizing wireless data transfer methods such as WiFi (IEEE 802.11), Wi-Max, Bluetooth™, ultra-wideband, infrared, or the like. In embodiments, the device 100 may further include a Frequency Modulated (FM) receiver for receiving information such as music, Radio Data system (RDS) information, FM Traffic Message Channel (TMC) information, direct band information such as MSN Direct™ data, or the like.

Data provided by the location determining component 116 may be used to by the processing system 112 to determine the geographic location of the device 100, to determine track logs or any other series of geographic coordinates corresponding to points along a path traveled by a user of the device 100 and/or to calculate routes to desired locations, provide instructions to navigate to the desired locations, display maps and other information on the display 118, and to execute other functions described herein. The location determining component 116 may include one or more processors, controllers, or other processing systems and memory or may utilize the components of the processing system 112.

In exemplary embodiments, the location determining component 116 comprises a global positioning system (GPS) receiver. The GPS receiver may be operable to receive navigational signals from GPS satellites to calculate a position of the device 100 as a function of the signals. However, it will be appreciated that other location-determining technology may be used in place or in addition to the GPS receiver. For example, a receiver suitable for use with other global navigation satellite systems (GNSS) may be used instead or in addition to the GPS receiver. Alternatively, the communications component 112 may be used to determine the location of the device 10 by receiving data from at least three transmitting locations and then performing basic triangulation calculations to determine the relative position of the device 100 with respect to the transmitting locations. For example, cellular towers or any customized transmitting radio frequency towers can be used instead of satellites. With such a configuration, any standard geometric triangulation algorithm can be used to determine the location of the electronic device 100.

In accordance with the present invention, the device 100 includes two or more location determining component antennas (two antennas 118 & 120 are illustrated) for receiving the satellite signals used by the location determining component 116. The antennas 118 & 120 may be patch antennas, linear antennas, helical antennas, or any other type of antenna that can be used with navigational devices. Moreover, the antennas 118 & 120 may be of the same type (e.g., two patch antennas, three linear antennas, etc.) or of different types (e.g., a patch antenna and a linear antenna, a patch antenna, a linear antenna and a helical antenna, etc.) depending on the design requirements of the device 100. In exemplary embodiments, each antenna 118 & 120 is contained within the housing 102 and is configured for use when the device 100 is in predetermined modes or operation or orientations as described more fully herein below.

As shown in FIGS. 1, 2, 4 and 5, each antenna 118 & 120 is configured and strategically mounted to device circuit boards 134 and positioned to optimize reception of external radio frequency signals (e.g., transmitted from the GPS Satellites) in one or more predetermined orientations while minimizing the overall size of the device 100 and optionally eliminating protrusions from the housing 102 of the device 100. In the embodiment illustrated, antenna 118 comprises a linear antenna while antenna 120 comprises a patch antenna. However, it is contemplated that other antenna types and configurations may be used for either or both of antennas 118 & 120 without departing from the scope and intent of the present invention.

The operational mode/detector 122 provides a functionality to determine an operational mode and/or an orientation of the device 100. The detector 122 may be configured in a variety of ways to provide signals to enable detection of manual manipulation of the device 100 including but not limited to detecting physical orientation, motion, docking with the mount 110, and so forth. For example, the detector 122 may be representative of various components used alone or in combination, such as a connector (or pin within a connector) suitable for coupling with the mount 110 whereupon coupling of the connector with the mount indicates a condition whereupon the operational mode of the device 100 is changed, an accelerometer 136, a gyroscope, a velocimeter, a capacitive or resistive touch sensor, and so on.

In exemplary embodiments, the detector 122 may comprise or alternately use signals from the location determining component (e.g., GPS receiver) 116. In such embodiments, the location determining component 116 may detect which of the antennas (e.g., antennas 118 & 122) has the better or best performance and cause that antenna 118 & 122 to be used. In specific embodiments, the GPS receiver 116 may override the selection of antenna 118 & 120 by other detector 122 components. For example, the location determining component 116 may select the antenna 118 & 120 regardless of the operational mode or orientation indicated by detector 122 components such as a mount connector, an accelerometer 122, or the like, even if such components indicate that another antenna 118 & 122 should be used due to the operational mode or orientation of the device 100.

The display 108 is coupled with the processing system 112 and is operable to display information to users of the device 100. The display 108 may comprise conventional black and white, monochrome, or color display elements including, but not limited to, Liquid Crystal Display (LCD), Thin Film Transistor (TFT) LCD, Light Emitting Polymer (LEP), Polymer Light Emitting Diode (PLED), Organic Light Emitting Diode (OLED) and/or plasma display devices. The display 108 may be backlit via a backlight such that it may be viewed in the dark or other low-light environments. As illustrated in FIG. 1, the display 108 is positioned on a front face of the housing 102 for ease of viewing. The display 108 may be generally rectangular in shape so that it may have a landscape orientation and a portrait orientation.

The display 108 may be integrated with a user interface 126, such as in embodiments where the display 108 is a touch-screen display (e.g., a resistive touch screen, a capacitive touch screen, etc.) to enable the user to interact with it by touching or pointing at display areas to provide information to the device 100. The user interface 126 permits a user to operate the device 100 and enables users to share information with the device 100.

Alternatively or in addition, the user interface 126 may comprise one or more functionable inputs such as buttons, switches, scroll wheels, a touch screen associated with the display, voice recognition elements such as a microphone, pointing devices such as track sticks, touchpads, trackballs, or styluses; a camera such as a digital still or video camera, or combinations thereof. The device 100 may also include a speaker and/or earpiece for providing voice communications, turn-by-turn instructions, sounds, music, and the like.

The memory 124 may be integral with the processing system 112, integral with the location determining component 116, stand-alone memory, or a combination of both. The memory may include, for example, removable and non-removable memory elements such as RAM, ROM, Flash (e.g., SD Card, mini-SD card, micro-SD Card), magnetic, optical, USB memory devices, or the like. In embodiments of the invention, memory 124 may include removable ICC (Integrated Circuit Card) memory such provided by SIM (Subscriber Identity Module) cards, USIM (Universal Subscriber Identity Module) cards, UICC (Universal Integrated Circuit Cards, or the like.

The memory 124 may store various data associated with operation of the device 100, such as the computer program and code segments mentioned above, or other data for instructing the processing system 112 and other device elements to perform the steps described herein. Further, the memory 124 may store various cartographic data corresponding to geographic locations including map data, and map elements, such as thoroughfares, terrain, alert locations, points of interest, geographic entities, radio stations, and other navigation data to facilitate the various navigation functions provided by the device 100. Additionally, the memory 124 may store destination addresses and previously calculated or otherwise acquired routes to various destination addresses for later retrieval by the processing system 112. Still further, the memory 124 may store address books, caller identification information, voice mail, IMs, text messages, and like telephony related information.

The power source 128 is associated with the housing 102 to provide electrical power to various device 100 elements. The power source 128 may comprise conventional power supply elements, such as batteries, battery packs, etc. The power source 128 may also comprise power conduits, connectors, and receptacles operable to receive batteries, battery connectors, or power cables. For example, the power source 128 may include both a battery to enable portable operation and a power input for receiving power from an external source such an automobile mount 110.

To preserve battery life, the GPS receiver or other location-determining component 116 may be switched off periodically. For example, the GPS receiver may be alternatively switched on for 30 seconds, off for two minutes, then back on for 30 seconds. If the location-determining component 116 determines the electronic device 100 is moving quickly (for example, if it is in an automobile), it may be switched on more frequently.

The I/O ports 130 permit data and other information to be transferred to and from the processing system 112 and the location determining component 116. The I/O ports 130 may include a Secure Disk (SD) card slot, Mini SD Card slot, Micro SD Card slot or the like for receiving removable SD cards, Mini SD Cards, Micro SD Cards, or the like, and a USB port for coupling with a USB cable connected to another computing device such as a personal computer, a removable ICC slot for receiving a removable ICC such as a SIM card, or the like. Navigational software, cartographic maps and other data and information may be loaded in the device 100 via the I/O ports or the communications component 114.

### EXEMPLARY OPERATION

In exemplary embodiments, the location determining component (e.g., the GPS receiver or the like) may be operable in two or more different modes of operation. In each of these modes of operation, the device 100 may be placed or held in one or more different orientations. For example, in the embodiment illustrated in FIGS. 1, and 2, the device 100 comprises a mobile phone having integrated navigation capability. In such an embodiment, the device 100 may have a first (hand-held) operational mode wherein the device 100 is primarily used as a hand-held mobile phone and a second (mounted) operational mode wherein the device 100 is primarily used as a personal navigation device mounted to a mount 110 within an automobile (or alternatively to a motorcycle, bicycle, boat, or the like). The device 100 may additionally or alternatively employ other operating modes, such as a gaming mode, a texting mode, a camera mode, a media playback mode, combinations thereof, and the like. When operated in the first operational mode the device 100 may have a first orientation wherein the device is held in the hand of a user so that in normal use the top surface 106 and display 108 of the device 100 face generally upward and the bottom surface 104 of the device 100 faces generally downward toward the ground or floor. This orientation is illustrated in FIG. 1. Similarly, when operated in the second operational mode, the device 100 may have a second orientation wherein the device 100 is docked in mount 110 so that it is held generally perpendicular to the ground. It will be appreciated that the device 100 may also be held in other orientations in either operational mode. For example, in the first operational mode the device 100 may commonly be held in an orientation wherein its earpiece rests against the user's ear and its microphone is held adjacent to the user's cheek, such as while the user is engaged in a telephone call. The display 108 of device (i.e., the mobile phone) 100 may be capable of use in both a portrait mode, most commonly used while the device 100 in the first operational mode and held in the first orientation (FIG. 1) and landscape mode, most commonly used while the device 100 is in the second operational mode an in the second orientation (illustrated in FIG. 2) for displaying information to the user. However, it will be appreciated that the display 108 may also be used in landscape mode while the device 100 is in the first operational mode in an orientation wherein the device is held in the hand of a user so that in normal use the top surface 106 and display 108 of the device 100 face generally upward and the bottom surface 104 of the device 100 faces generally downward toward the ground or floor.

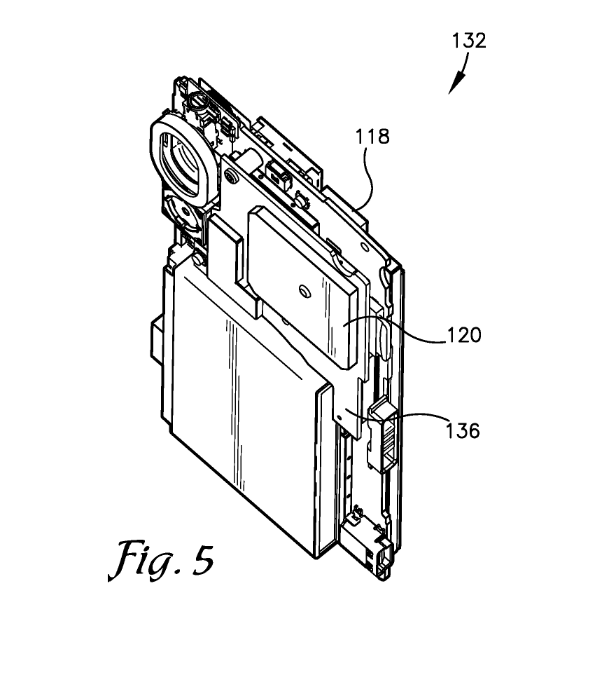

As shown in FIGS. 1 through 5, the location determining component 116 employs two or more antennas (two antennas 118 & 120 are illustrated) each configured for use when the device 100 is in one or more modes of operation or orientations for receiving a signals used by the location determining component 116 for determining the geographic position of the device 100. For example, in the specific embodiment illustrated wherein the device 100 comprises a mobile phone having integrated navigation capability, the device 100 may include a first antenna 118 disposed in the housing 102 which is configured and positioned for greatest efficiency when the device 100 is in the first (hand held) operational mode as illustrated in FIG. 1. As shown in FIGS. 4 and 5, the first antenna 118 may comprise a linear antenna mounted to the device's printed circuit board 132 near an edge of the board 132 (as viewed when the device 100 in oriented in the first orientation for hand held use) which employs traces of the circuit board 132 as conductors. The device 100 may further include a second antenna 120 disposed in the housing which is configured and positioned for greatest efficiency when the device 100 is in the second (mounted) operational mode as illustrated in FIG. 2. As shown in FIGS. 4 and 5, the second antenna 120 may comprise a patch antenna mounted having a printed circuit board or metal ground plane 136 mounted to back of the device's main printed circuit board 132 opposite the first antenna 118.

In embodiments of the invention, the processing system 112 or location determining component 116 selects the antenna which generally optimizes receipt of signals for the location determining component 116 based on one or both of the operational mode of the device 100 and the orientation of the device 100 as determined by the detector 122. The detector 122 may be configured in a variety of ways to provide signals to enable detection of manual manipulation of the device 100 including but not limited to detecting physical orientation, motion, docking with the mount 110, and so forth. In this manner, the detector 122 may detect a condition (e.g., the device 100 is received in the mount 110 or removed from the mount 110) whereupon the processing system may select an operational mode for the device 100. For example, in the embodiment illustrated wherein the device 100 comprises a mobile phone having navigation capability, the detector 122 may comprise a connector or pin within a connector for detecting whether the device 100 is docked to the mount 110. When the detector 122 detects that the device 100 is not docked in the mount 110, the processing system 112 may place the device in hand held mode wherein the first antenna 118 is selected for use. When the detector 122 detects that the device 10 is docked in the mount 110, the processing system may thereafter place the device in the second (mounted) operational mode wherein the second antenna is selected for use. In some embodiments, the detector 122 may comprise a portion of the processing system 122 and/or memory 124 to enable the detector 122 to determine the operating mode of the device 100 when a user manually sets the operating mode utilizing the user interface 126.

The operational mode/detector 122 may alternately or additionally comprise a component for determining the physical orientation of the device 100, movement of the device 100, or the like. For example, in the embodiment illustrated wherein the device 100 comprises a mobile phone having navigation capability, the detector 122 may detect orientation of the device 100 via an accelerometer 136. When the detector 122 detects that the device is in the first orientation (wherein the device is held in the hand of a user so that in normal use the top surface 106 and display 108 of the device 100 face generally upward and the bottom surface 104 of the device 100 faces generally downward toward the ground or floor) the processing system 112 may cause the first antenna 118 to be selected for use. When the detector 122 detects that device has been placed in the second orientation, wherein it is docked in the mount 110 or the user has lifted the device to an orientation wherein its earpiece rests against the user's ear and its microphone is held adjacent to the user's cheek, such as while the user is engaged in a telephone call, the processing system 112 may cause the second antenna 120 to be selected for use.

It is contemplated that in embodiments of the invention, the operational mode and orientation of the device 100 may correspond directly to one another. For example, the device 100 may enter a different operational mode each time the detector 122 detects that it is in a different orientation. However, in other embodiments, the operational mode of the device 100 need not correspond directly to its orientation. In such embodiments the antenna used may be selected based on the device's orientation regardless of its operational mode (e.g., if the user rotates the device in a navigation mode, the correct antenna may be automatically selected without changing to a phone mode, or that when the device is in phone mode, one of the antennas is selected regardless of the device's orientation, etc.). Similarly, in other embodiments, the antenna used may be selected based on the device's operational mode regardless of its orientation (e.g., if the user rotates the device in a phone mode, the antenna selected is not changed even if the device is rotated to the orientation in which the device is normally held when received in the mount 110, etc.).

It will be appreciated that the detector 122 may comprise both a component for detecting the operational mode of the device 100 (e.g., a connector or pin within a connector) and a component for detecting the physical orientation of the device (e.g., an accelerometer 136) whereupon the processing system 112 may determine the appropriate antenna 118 & 120 to be selected for use based on a combination of operational mode and/or orientation of the device 100. Further discussion of the operation of an detector such as detector 122 to perform automatic device mode switching may be found in the copending U.S. patent application of Lawrence W. Beason, application Ser. No. ______, filed on Jan. 24, 2008 and titled Automatic Device Mode Switching, which is herein incorporated by reference in its entirety.

### CONCLUSION

Although the invention has been described with reference to exemplary embodiments illustrated in the attached drawing figures, it is noted that equivalents may be employed and substitutions made herein without departing from the scope of the invention as recited in the claims. For example, Further, the device 100 and its components illustrated and described herein are merely examples of a device and components that may be used to implement the present invention and may be replaced with other devices and components without departing from the scope of the present invention.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A device, comprising:
a housing;
a location determining component disposed within the housing for determining a geographic location of the device;
a first antenna disposed in the housing and operable for receiving a signals used by the location determining component for determining the geographic location of the device; and
a second antenna disposed in the housing and operable for receiving a signals used by the location determining component for determining the geographic position of the device,
wherein the location determining component uses signals received by the first antenna when the device is in at least one of a first operational mode and a first orientation and signals received by the second antenna when the housing in at least one of a second operational mode and a second orientation.

2. The device as claimed in claim 1, further comprising a detector for at least one of detecting a condition whereupon the device is set in the first operational mode or the second operational mode and detecting when the device is in the first orientation or the second orientation.

3. The device as claimed in claim 2, wherein the detector comprises at least one of a connector and a pin within a connector for detecting when the device is docked in a mount.

4. The device as claimed in claim 2, wherein the detector comprises an accelerometer.

5. The device as claimed in claim 1, further comprising a processing system for determining whether the device is in at least one of the first operational mode or the second operational mode and the first orientation or the second orientation.

6. The device as claimed in claim 1, further comprising a circuit board disposed in the housing, the location determining component and at least one of the first antenna and the second antenna being mounted to the circuit board.

7. The device as claimed in claim 1, wherein at least one of the first antenna and the second antenna comprises a patch antenna.

8. The device as claimed in claim 1, wherein at least one of the first antenna and the second antenna comprises a linear antenna.

9. The device as claimed in claim 1, wherein the first antenna comprises a patch antenna and the second antenna comprises a linear antenna.

10. The device as claimed in claim 1, wherein the device is hand held in the first operational mode and is received in a mount in the second operational mode.

11. The device as claimed in claim 1, further comprising a communication component for enabling the device communicate with other electronic devices through a communication network.

12. The device as claimed in claim 11, wherein the communication network comprises a cellular telephone network.

13. A device, comprising:
a housing;
a location determining component disposed within the housing for determining a geographic location of the device;
a first antenna disposed in the housing and operable for receiving signals used by the location determining component for determining the geographic location of the device when the device is in a first operational mode; and
a second antenna disposed in the housing an operable for receiving a signals used by the location determining component for determining the geographic location of the device when the device is in a second operational mode;
a detector for detecting a condition whereupon the device is set in the first operational mode or the second operational mode.

14. The device as claimed in claim 13, further comprising a processing system for setting the device in the first operational mode or the second operational mode.

15. The device as claimed in claim 13, wherein the location determining component comprises a GPS receiver and the first and second antennas comprise GPS antennas.

16. The device as claimed in claim 14, wherein at least one of the first antenna and the second antenna comprises a patch antenna.

17. The device as claimed in claim 15, wherein the patch antenna comprises a ground plane.

18. The device as claimed in claim 16, wherein the ground plane comprises a second circuit board.

19. The device as claimed in claim 14, wherein at least one of the first antenna and the second antenna comprises a linear antenna.

20. The device as claimed in claim 14, wherein the first antenna comprises a patch antenna and the second antenna comprises a linear antenna.

21. The device as claimed in claim 13, wherein the detector comprises at least one of a connector and a pin within a connector for detecting when the device is docked in a mount or an accelerometer for detecting an orientation of the device.

22. The device as claimed in claim 13, further comprising a circuit board disposed in the housing, the location determining component and at least one of the first antenna and the second antenna being mounted to the circuit board

23. The device as claimed in claim 13, wherein the device is hand held in the first operational mode and is received in a mount in the second operational mode.

24. The device as claimed in claim 13, further comprising a communication component for enabling the device communicate with other electronic devices through a communication network.

25. The device as claimed in claim 23, wherein the communication network comprises a cellular telephone network.

26. A device, comprising:
a housing;
a location determining component disposed within the housing for determining a geographic location of the device;
a first antenna disposed in the housing and operable for receiving signals used by the receiver for determining the geographic position of the device when the device is in a first orientation;
a second antenna disposed in the housing and operable for receiving a signals used by the receiver for determining the geographic position of the device when the device is in a second orientation, and
a detector for sensing whether the housing is in the first orientation or the second orientation,
wherein the location determining component uses signals received by the first antenna when the housing is in a first orientation and signals received by the second antenna when the housing in a second orientation.

27. The device as claimed in claim 26, further comprising a processing system coupled to the detector for determining whether the housing is in the first orientation or the second orientation and selecting the first antenna or the second antenna for use by the location determining component.

28. The device as claimed in claim 26, wherein the location determining component comprises a GPS receiver and the first and second antennas comprise GPS antennas

29. The device as claimed in claim 28, wherein at least one of the first antenna and the second antenna comprises a patch antenna.

30. The device as claimed in claim 28, wherein at least one of the first antenna and the second antenna comprises a linear antenna.

31. The device as claimed in claim 28, wherein the first antenna comprises a patch antenna and the second antenna comprises a linear antenna.

32. The device as claimed in claim 35, wherein the detector comprises an accelerometer.

33. The device as claimed in claim 13, further comprising a communication component for enabling the device communicate with other electronic devices through a communication network.

34. The device as claimed in claim 23, wherein the communication network comprises a cellular telephone network.

35. A method of selecting one of a plurality of antennas for use by a device including a location determining component operable to utilize at least one of the antennas, the method comprising:
determining at least one of an operational mode and an orientation of the device; and
selecting one of the antennas for use by the device based on the determined operational mode and/or orientation.

36. The method as claimed in claim 35, wherein determining at least one of an operational mode and an orientation comprises detecting when the device is docked in a mount.
